(19) United States
(12) Patent Application Publication
(10) Pub. No.: US 2021/0402854 A1
(43) Pub. Date: Dec. 30, 2021

(54) WINDOW GLASS SYSTEM AND WINDOW GLASS

(71) Applicant: AGC Inc., Tokyo (JP)

(72) Inventors: Kazuyoshi NODA, Tokyo (JP); Tetsuji IRIE, Tokyo (JP); Takayuki KIMURA, Tokyo (JP); Shinya TANAKA, Tokyo (JP); Sangmun LEE, Tokyo (JP)

(73) Assignee: AGC Inc., Tokyo (JP)

(21) Appl. No.: 17/472,475

(22) Filed: Sep. 10, 2021

Related U.S. Application Data
(63) Continuation of application No. PCT/JP2020/009848, filed on Mar. 6, 2020.

(30) Foreign Application Priority Data
Mar. 15, 2019 (JP) 2019-049041
Dec. 11, 2019 (JP) 2019-224051

(51) Int. Cl. B60J 1/00; B60S 1/02; B60H 3/02; H05B 1/02; H05B 3/84; G01K 1/14

(52) U.S. Cl. CPC B60J 1/002; B60S 1/026; B60H 3/024; H05B 2203/013; H05B 3/84; G01K 1/14; H05B 1/0236

(57) ABSTRACT

A window glass system includes a window glass to be attached to a moveable body, an anti-fog film to be provided on a cabin-side surface of the window glass, a temperature sensor configured to detect a glass temperature of the vehicle cabin-side surface of the window glass, a temperature-and-humidity sensor configured to detect a temperature and a humidity of a cabin of the moveable body, drying means configured to vaporize water attached to the anti-fog film, and a processing circuitry configured to estimate a time duration Ts, based on the glass temperature detected by the temperature sensor and the temperature and the humidity of the cabin detected by the temperature-and-humidity sensor, the time duration Ts being a duration of time until fogging occurs on the anti-fog film, and activate the drying means based on the time duration Ts.

### CROSS-REFERENCE TO RELATED APPLICATION

The present application is a continuation application filed under 35 U.S.C. 111 (a) claiming benefit under 35 U.S.C. 120 and 365 (c) of PCT International Application No. PCT/JP2020/009848 filed on Mar. 6, 2020 and designating the U.S., which claims priority to Japanese Patent Application No. 2019-049041 filed on Mar. 15, 2019 and Japanese Patent Application No. 2019-224051 filed on Dec. 11, 2019. The entire contents of the foregoing applications are incorporated herein by reference.

### BACKGROUND OF THE INVENTION

### 1. Field of the Invention

The present invention relates to a window glass system and a window glass.

### 2. Description of the Related Art

Conventionally, there is a vehicular anti-fog window system wherein detection means detects the situations of water attached to a plate-shaped body for window attached to a vehicle, control means activates drying means according to an output of the detection means to vaporize water attached to the plate-shaped body for the window, the plate-shaped body for the window has an anti-fog coating on the vehicle cabin-side surface, the detection means detects the amount of water attached to the anti-fog coating, the control means operates to transmit a signal for activating the drying means when the water detection sensor detects the amount of water greater than a threshold value, and the drying means operates according to the signal to vaporize the water attached to the anti-fog coating (for example, see PTL 1).

### CITATION LIST

### Patent Literature

[PTL 1] Japanese Laid-Open Patent Publication No. 2006-264458

### SUMMARY OF THE INVENTION

### Technical Problem

The conventional vehicular anti-fog window system activates the drying means when the detection value of the water detection sensor becomes more than a threshold value, but the amount of saturation water absorption at which the water absorption performance of the anti-fog coating (the anti-fog film) is saturated changes according to the temperature and the humidity of the cabin of the vehicle.

Therefore, in the conventional system, fogging may occur on the anti-fog film when the detection value of the water detection sensor becomes more than the threshold value.

Accordingly, it is an object to provide a window glass system and a window glass with an improved anti-fog performance.

### Solution to Problem

A window glass system according to an embodiment of the present invention includes a window glass to be attached to a moveable body, an anti-fog film to be provided on a cabin-side surface of the window glass, a temperature sensor configured to detect a glass temperature of the cabin-side surface of the window glass, a temperature-and-humidity sensor configured to detect a temperature and a humidity of a cabin of the moveable body, drying means configured to vaporize water attached to the anti-fog film, and a processing circuitry configured to estimate a time duration Ts, based on the glass temperature detected by the temperature sensor and the temperature and the humidity of the cabin detected by the temperature-and-humidity sensor, the time duration Ts being a duration of time until fogging occurs on the anti-fog film, and activate the drying means based on the time duration Ts.

Further, window glass according to an embodiment of the present invention includes glass attached to a moveable body, an anti-fog film to be provided on a cabin-side surface of the glass, a temperature sensor configured to detect a glass temperature of the cabin-side surface of the glass, a temperature-and-humidity sensor configured to detect a temperature and a humidity of a cabin of the moveable body, and an electric heating wire or an electric heating film provided in an area that overlaps, in a plan view, with an area where the anti-fog film is provided.

### Advantageous Effects of Invention

A window glass system and a window glass with an improved anti-fog performance can be provided.

### BRIEF DESCRIPTION OF THE DRAWINGS

FIG. 1 is a drawing illustrating a vehicle 10 provided with a window glass system 100 according to an embodiment;

FIG. 2 is a drawing illustrating an example of the window glass system 100;

FIG. 3 is a drawing illustrating another example of a window glass system 100;

FIG. 4 is a drawing illustrating a flowchart of processing executed by a controller 150C;

FIG. 5 is a drawing illustrating a flowchart of a modified embodiment of processing executed by the controller 150C;

FIG. 6 is a drawing illustrating a structure of a bracket 280 and a housing 290 for attaching an information acquisition apparatus 270 to a glass main body 111;

FIG. 7 is a drawing illustrating the structure of the bracket 280 and the housing 290 for attaching the information acquisition apparatus 270 to the glass main body 111;

FIG. 8 is a drawing illustrating the structure of the bracket 280 and the housing 290 for attaching the information acquisition apparatus 270 to the glass main body 111; and

FIG. 9 is a drawing illustrating a bracket 280M according to a modified embodiment of the embodiment.

### DETAILED DESCRIPTION OF THE PREFERRED EMBODIMENTS

Hereinafter, an embodiment to which a window glass system and a window glass according to the present invention are applied is described below.

### Embodiment

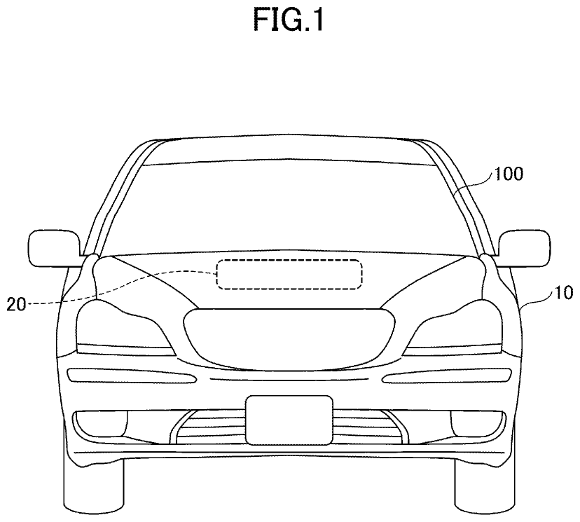

FIG. 1 is a drawing illustrating an example of a vehicle 10 provided with a window glass system 100 according to the embodiment. For example, the window glass system 100 is attached to the vehicle 10 as a front windshield. The window glass system 100 includes an anti-fog film 120, and includes drying means for vaporizing water attached to the anti-fog film 120. For example, the drying means includes a defroster 20. The defroster 20 is a device that blows air dehumidified by an air conditioner toward the window glass system 100 to remove fogging when the defroster 20 is activated.

In this case, the vehicle 10 is a vehicle such as, for example, an electric vehicle (EV), a plug-in hybrid vehicle (PHV), a hybrid vehicle (HV), a gasoline vehicle, or a diesel vehicle. Further, the vehicle 10 may be an electric train or a steam train. The vehicle 10 is an example of a moveable body that moves while carrying occupants.

Also, in this case, an aspect in which the window glass system 100 is attached to the vehicle 10 is explained, but the window glass system 100 may be attached to a moveable body (for example, aircraft, a helicopter, and the like) other than the vehicle 10.

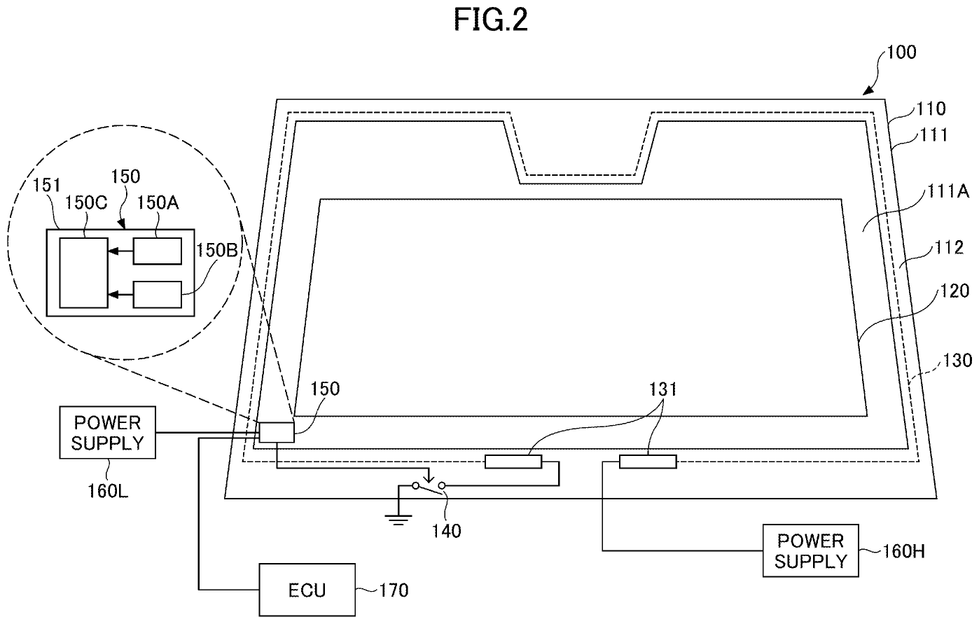

FIG. 2 is a drawing illustrating an example of the window glass system 100. The window glass system 100 includes a window glass 110, the anti-fog film 120, an electric heating wire 130, a switch 140, a control unit 150 (a temperature sensor 150A, and a temperature-and-humidity sensor 150B, and a controller 150C). A power supply 160H is connected to the electric heating wire 130. A power supply 160L and an electronic control unit (ECU) 170 are connected to the control unit 150. The electric heating wire 130 is an example of drying means.

The following explanation is made by using upper and lower directions when the window glass system 100 is attached to the vehicle 10. In the invention of the present application, ab upper portion, a lower portion, and side portions of the glass main body 111 mean an upper portion, a lower portion, and side portions, respectively, when the glass main body 111 is attached to the vehicle 10.

The window glass 110 includes a glass main body 111. The window glass 110 may further include a shielding area.

The glass main body 111 may be laminated glass in which an interlayer film is sealed. The shielding area is preferably provided along the periphery of the glass main body 111 on the surface of the vehicle-cabin (the cabin of the vehicle 10) side of the glass main body 111.

The shielding area is an area in which a colored layer is formed or is a colored area of an interlayer film. The colored layer is a colored ceramic layer 112 or a colored organic ink layer. The colored ceramic layer 112 is, for example, a fired body of a dark ceramic paste. The shielding area is formed in order to prevent an adhesive from being degraded by ultraviolet rays while the glass main body 111 is bonded to the vehicle 10 and in order to improve the appearance by hiding the connection portion between the glass main body 111 and the vehicle body from the outside of the vehicle 10. A central portion 111A of the glass main body 111 surrounded by the shielding area is a transparent portion. Also, in a case where the glass main body 111 is laminated glass, the colored ceramic layer 112 or the colored organic ink layer is preferably provided in contact with the interlayer film, or provided on the vehicle cabin-side surface of the glass main body 111.

The anti-fog film 120 is provided on the surface of the cabin side of the window glass 110. The anti-fog film 120 is preferably provided on the vehicle-cabin (the cabin of the vehicle 10) side of the central portion 111A of the glass main body 111.

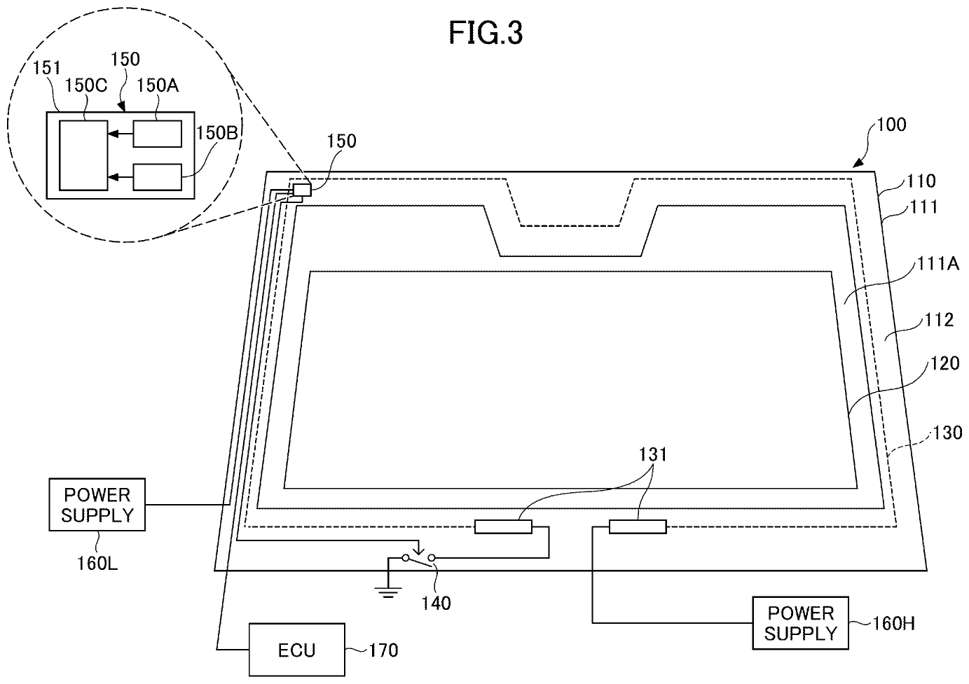

Also, as illustrated in FIG. 3, the area in which the anti-fog film 120 is provided may overlap with the shielding area in the plan view. FIG. 3 is a drawing illustrating another example of a window glass system 100. An overlap between the area where the anti-fog film 120 is provided and the shielding area is preferably on the lower portion and/or one of the side portions of the glass main body 111. When the overlap is in the lower portion and/or one of the side portions of the glass main body 111, fogging of the window glass 110 can be effectively delayed.

Also, at least a portion of the area where the anti-fog film 120 is provided preferably does not overlap with a heating area heated by the electric heating wire 130. When the portion does not overlap with heating area, the visibility of the area where the anti-fog film 120 is provided can be improved.

The anti-fog film 120 has a water absorption property. In order to achieve a high water absorption property, the anti-fog film 120 preferably includes water-absorbent polymer or hydrophilic polymer. The anti-fog film 120 may be attached to the window glass 110 via a film having a pressure-sensitive adhesive layer.

The electric heating wire 130 is an example of drying means.

In the plan view, the heating area of the electric heating wire 130 overlaps with the area where the anti-fog film 120 is provided. When the heating area of the electric heating wire 130 and the area where the anti-fog film 120 is provided overlap with each other, water contained in the anti-fog film 120 evaporates, and the amount of water absorbed in the anti-fog film 120 is reduced efficiently.

In the plan view, the heating area of the electric heating wire 130 preferably includes an area that does not overlap with the area where the anti-fog film 120 is provided. When the temperature sensor 150A is provided in an area of the heating area of the electric heating wire 130 that does not overlap with the area where the anti-fog film 120 is provided, the temperature sensor 150A can be alleviated from being affected by the anti-fog film 120. Further, the area where the electric heating wire 130 is provided may include the area where the anti-fog film 120 is provided.

The electric heating wire 130 is preferably provided on the surface of the cabin side of the central portion 111A of the glass main body 111. The electric heating wire 130 is, for example, a tungsten conductive trace, and includes terminals 131 at both ends. The electric heating wire 130 may be a silver conductive trace. The terminals 131 are, for example, silver foil busbars obtained by printing silver (Ag).

One of the terminals 131 (on the left-hand side in the drawing) is connected to the switch 140, and the other of the terminals 131 (on the right-hand side in the drawing) is connected to the power supply 160H.

In a case where the glass main body 111 is laminated glass, the electric heating wire 130 is preferably provided between two pieces of glass, and sandwiched between interlayer films that bond both pieces of the glass. The electric heating wire 130 may be provided on the vehicle cabin-side surface of the laminated glass. The electric heating wire 130 may be provided in the shielding area, and may be provided on the colored ceramic layer 112 or the colored organic ink layer.

In the window glass system 100 according to the present invention, the electric heating wire 130 may be replaced with an electric heating film. The electric heating film is preferably provided in the central portion 111A of the glass main body 111. The electric heating film is, for example, an indium tin oxide (ITO) transparent film, and is connected to the terminals 131. The electric heating film is an example of drying means.

The switch 140 may be provided in the shielding area on the vehicle cabin-side surface of the glass main body 111.

The switch 140 is inserted in series between one of the terminals of the electric heating wire 130 or the electric heating film and the ground potential point of the vehicle 10. The switching between the ON and OFF states of the switch 140 is performed by the control unit 150 or the ECU 170. The switching by the ECU 170 may be performed on the basis of a signal that is output from the control unit 150. Alternatively, the switch 140 does not have to be provided, and the control unit 150 or the ECU 170 may change the electric heating wire 130 or the electric heating film attached to the window glass 110 to either an energized state or a non-energized state. The control by the ECU 170 may be performed on the basis of a signal that is output from the control unit 150.

The control unit 150 may be provided on the vehicle cabin-side surface of the central portion 111A of the glass main body 111. The control unit 150 includes the controller 150C, the temperature sensor 150A, and the temperature-and-humidity sensor 150B. The controller 150C turns ON or OFF the electric heating wire 130 or the electric heating film attached to the window glass 110.

The temperature sensor 150A is preferably provided on the surface of the cabin side of the window glass 110. In the plan view, the temperature sensor 150A is preferably provided in the shielding area. When the temperature sensor 150A is in the shielding area, the appearance can be improved so that the temperature sensor 150A cannot be seen from the outside of the vehicle 10. The temperature sensor 150A may be provided on the colored ceramic layer 112 or the colored organic ink layer provided on the surface of the cabin side of the window glass 110.

The temperature sensor 150A is preferably provided on the lower portion, the upper portion, or one of the side portions of the glass main body 111. In particular, when the temperature sensor 150A is provided on the upper portion or one of the side portions, fogging that occurs due to cruising of the vehicle can be readily detected. The temperature sensors 150A may be provided on all of the corner portions of the glass main body 111. When the temperature sensors 150A are provided on all of the corners, all of the fogging that occurs can be readily detected regardless of the structure of the vehicle-cabin. Further, the temperature sensor 150A may be provided on the driver's seat side of the glass main body 111. For example, the temperature sensor 150A is preferably provided on the upper portion side of the central portion 111A of the glass main body 111 in proximity to the border with the shielding area.

Also, in the plan view, the temperature sensor 150A is preferably provided on the outside of the area where the anti-fog film 120 is provided. In particular, in the plan view, the temperature sensor 150A is preferably provided between the shielding area and the area where the anti-fog film 120 is provided. When the temperature sensor 150A is provided between the shielding area and the area where the anti-fog film 120 is provided, the glass temperature can be detected accurately.

Further, in the plan view, the temperature sensor 150A may be provided in the heating area heated by the electric heating wire 130 or the electric heating film. When the temperature sensor 150A is provided in the heating area, timing for causing the electric heating wire 130 or the electric heating film to be in the energized state and timing for causing the electric heating wire 130 or the electric heating film to be in the non-energized state can be ascertained accurately.

The control unit 150 may further include a housing 151 fixed to the shielding area. The controller 150C, the temperature sensor 150A, and the temperature-and-humidity sensor 150B are contained inside the housing 151. Electric power is supplied from the power supply 160L to the controller 150C, the temperature sensor 150A, and the temperature-and-humidity sensor 150B.

The controller 150C is implemented by a computer (such as a processing circuitry, a circuit, or the like) that includes a central processing unit (CPU), random access memory (RAM), read only memory (ROM), an internal bus, and the like. The controller 150C performs control to cause the electric heating wire 130 or the electric heating film to be in the energized state, and then cause it to be in the non-energized state after a predetermined time elapses, on the basis of the temperature of the glass main body 111 detected by the temperature sensor 150A and the temperature and the humidity of the vehicle-cabin detected by the temperature-and-humidity sensor 150B. The controller 150C is preferably provided in proximity to the ECU 170. The ECU 170 is often provided at a location that is less likely to be affected by solar radiation, and accordingly, the controller 150C can also avoid the adverse effect of solar radiation in a similar manner. In this case, the temperature sensor 150A is preferably provided to be in contact with the glass main body 111, and the temperature-and-humidity sensor 150B is preferably provided in a thermal boundary layer of the glass main body 111. Hereinafter, the temperature of the glass main body 111 detected by the temperature sensor 150A is referred to as a glass temperature. The content, a predetermined time, and the like of the control performed by the controller 150C are explained later.

The controller 150C may be connected to any one of multiple electronic control units (ECUs) provided on the vehicle 10 via a network. For example, when the controller 150C is connected to an ECU for the air conditioner, the window glass system 100 can be activated according to the operation of the air conditioner. The power supply for the entire window glass system 100 can be turned ON and OFF by an operation unit of an air conditioner and the like.

The temperature sensor 150A detects the glass temperature. The temperature sensor 150A is preferably in contact with the glass main body 111. The temperature-and-humidity sensor 150B detects the temperature and the humidity of the vehicle-cabin of the moveable body. The temperature-and-humidity sensor 150B is preferably away from the glass main body 111. The temperature-and-humidity sensor 150B may be a single chip integrally including a temperature sensor and a temperature-and-humidity sensor. The temperature sensor 150A and the temperature-and-humidity sensor 150B are connected to the controller 150C, and output data representing the glass temperature, the temperature of the vehicle-cabin, and the humidity of the vehicle-cabin to the controller 150C. The temperature sensor 150A and the temperature-and-humidity sensor 150B may be sensors of wireless communication type. The temperature-and-humidity sensor 150B may be a sensor provided on the vehicle.

The temperature sensor 150A and the temperature-and-humidity sensor 150B are preferably provided adjacent to each other. When both of the sensors are provided adjacent to each other, a wiring structure can be simplified.

Instead of the temperature-and-humidity sensor 150B, a temperature sensor and a humidity sensor may be used separately. For example, a thermocouple can be used as a temperature sensor for detecting the temperature of the vehicle-cabin. For example, a sensor that outputs a resistance value of an element that changes according to a change in the humidity or a sensor that outputs an electrostatic capacitance of an element that changes according to a change in the humidity can be used as the humidity sensor for detecting the humidity of the vehicle-cabin.

The power supply 160H is connected between the other of the terminals 131 of the electric heating wire 130 and the battery and/or the generator of the vehicle 10, and supplies the power from the battery and/or the generator to the electric heating wire 130 or the electric heating film. The output voltage of the power supply 160H is higher than the output voltage of the power supply 160L. For example, the power supply 160H supplies power at a voltage of 12V to the electric heating wire 130.

The power supply 160L is connected between the control unit 150 and the battery and/or the generator of the vehicle 10, and supplies the power from the battery and/or the generator to the control unit 150. The output voltage of the power supply 160L is less than the output voltage of the power supply 160H, and is, for example, 5V.

First, timing at which the controller 150C activates and stops the drying means is explained.

The amount of water that can be absorbed by the anti-fog film 120 (the amount at which the water absorption performance is saturated (the amount of saturation water absorption)) changes according to the temperature and the humidity. The anti-fog film 120 starts to fog up when the amount of water absorption becomes more than the amount of saturation water absorption. In other words, the anti-fog film 120 can delay the timing of fogging as compared with window glass without any anti-fog film 120.

The controller 150C calculates the remaining time until the anti-fog film 120 is expected to fog up, on the basis of the glass temperature detected by the temperature sensor 150A and the temperature and the humidity of the cabin of the moveable body detected by the temperature-and-humidity sensor 150B. When the remaining time reaches a preset time, the controller 150C activates the drying means. The drying means includes the defroster 20 and the electric heating wire 130 or the electric heating film.

Also, the controller 150C performs control to stop the drying means, when a predetermined time elapses since the drying means is activated. When the electric heating wire 130 or the electric heating film is turned ON to raise the glass temperature, the water included in the anti-fog film 120 evaporates, and the amount of water absorption of the anti-fog film 120 decreases. When the defroster 20 is turned on, the amount of water absorption of the anti-fog film 120 decreases in a similar manner.

Therefore, the predetermined time from when the controller 150C activates the drying means to when the controller 150C stops the drying means can be set to, for example, a time required to cause the amount of water absorption of the anti-fog film 120 to become equal to or less than a predetermined rate (for example, equal to or less than 70%), i.e., a rate before the electric heating wire 130 is changed to the energized state.

For example, when the predetermined time is set to a time required to cause the amount of water absorption of the anti-fog film 120 at the maximum amount to become equal to or less than a predetermined rate (for example, equal to or less than 70%), i.e., a rate before the electric heating wire 130 is changed to the energized state, then, the anti-fog film 120 does not fog up for a certain period of time, regardless of what the amount of water absorption is.

Next, a method for estimating an occurrence of fogging of the anti-fog film 120 is explained. In order to estimate an occurrence of fogging of the anti-fog film 120, the timing of an occurrence of fogging can be more accurately estimated even under transient response conditions caused by rapid changes in the temperature and the humidity and under conditions in which the water absorption speed is slow in a low temperature environment, when a relative water absorption rate FRH of the outermost surface of the anti-fog film 120 is adopted as an index rather than when the water absorption state of the entire anti-fog film 120 is adopted as an index. Specifically, the invention of the present application is characterized in that, instead of adopting the amount of all the water attached to the anti-fog film 120 as an index, the relative water absorption rate of the outermost surface of the anti-fog film 120 is adopted as an index.

The water diffusion coefficient in the material of the anti-fog film 120 is a function of the temperature, and the diffusion coefficient decreases as the temperature of the glass substrate decreases.

The water diffusion coefficient is a function of the activation energy of the water in the material, and diffusion coefficients at multiple different temperatures can be obtained according to measurement methods such as JIS7209-2000 (ISO62-1999) Plastics-Determination of water absorption.

The water absorption speed of the outermost surface of the anti-fog film 120 is determined by a difference between the water vapor pressure of air having any given temperature and humidity and the water vapor pressure of the outermost surface of the anti-fog film 120 having any given temperature and water absorption.

Ordinary glass not having any anti-fog film 120 simply fogs up when the glass temperature becomes equal to or less than a dew point of air at a certain temperature and a certain humidity. In contrast, when the water absorption speed of the anti-fog film 120 from the air in the vehicle-cabin to the outermost surface of the anti-fog film 120 is larger than the water diffusion speed of the anti-fog film 120 from the outermost surface to the inside of the anti-fog film 120, the outermost surface is saturated and fogging occurs, even when the anti-fog film 120 is not saturated with water absorption.

When the anti-fog film 120 fogs up, although the relative water absorption rate FRH of the outermost surface of the anti-fog film 120 reaches approximately 100%, the relative water absorption rate FRH of the inner portion of the film has not reached 100%, and thus, generally, there still remains a capability of absorbing the water. In the process of drying of the anti-fog film 120, the outermost surface of the anti-fog film 120 is in a dry state, but the relative water absorption rate FRH of the inner portion of the anti-fog film 120 is generally higher than the relative water absorption rate FRH of the outermost surface.

Under the condition where a large number of people get in the vehicle 10 and the humidity inside the vehicle increases rapidly, or under the condition where the saturation vapor pressure is low and the water absorption speed of the anti-fog film 120 is low due to a low temperature, the relative water absorption rate FRH of the inner portion of the film may be about 70% even when the outermost surface of the anti-fog film 120 fogs up.

Immediately before the occupants get in the vehicle 10, the relative water absorption rate FRH of the anti-fog film 120 is in equilibrium with the humidity of the air in the vehicle-cabin. Specifically, the water vapor pressure of the anti-fog film 120 is equal to the water vapor pressure of the vehicle-cabin. Also, the outermost surface to the innermost portion of the anti-fog film 120 have the same water vapor pressure. Even in a case where the glass temperature and the temperature of the vehicle-cabin are different, the water vapor pressure of the inner portion of the film at that glass temperature is equal to and in equilibrium with the water vapor pressure at the room temperature.

Based on the above ideas, the water concentration distributions of the outermost surface, the inside (the inner portion), and the deepest portion of the anti-fog film 120 after a time At are predicted by the Fick's law (the diffusion equation of the concentration gradient). The water concentration distribution up until 10 minutes later with the same condition (a state in which the glass temperature and the temperature and the humidity of the vehicle-cabin do not change) continuing for, for example, 10 minutes, is calculated.

The relative water absorption rate FRH of the outermost surface of the anti-fog film 120 is monitored, and when this relative water absorption rate FRH reaches 100%, it is determined that fogging has occurred. In this case, the relative water absorption rate FRH of the outermost surface of the anti-fog film 120 is obtained by dividing a water absorption mass concentration FD by a saturation water absorption mass concentration FW of the outermost surface of the anti-fog film 120. In this manner, the invention of the present application is characterized in that the future relative water absorption rate of the outermost surface of the anti-fog film 120 is predicted.

The remaining time until when fogging is expected to occur is set to a preconfigured remaining time (for example, 30 seconds), and when the remaining time reaches zero, a mode for drying the anti-fog film 120 is entered by causing the electric heating wire 130 or the electric heating film to be in the energized state or activating the defroster 20.

When the electric heating wire 130 or the electric heating film is caused to be in the energized state, the remaining time is, for example, 10 minutes or more, and accordingly, the electric heating wire 130 or the electric heating film is turned ON until the relative water absorption rate FRH of the outermost surface of the anti-fog film 120 reaches a preconfigured relative water absorption rate (for example, 80%), and when the relative water absorption rate FRH of the outermost surface becomes less than 80%, the electric heating wire 130 or the electric heating film is caused to be in the non-energized state. The above is also applicable when the defroster 20 is activated.

Next, an occurrence of fogging at the interface between the air in the vehicle-cabin and the outermost surface of the anti-fog film 120 is explained. A flow of water vapor at the interface between the air in the vehicle-cabin and the outermost surface of the anti-fog film 120 is calculated according to the following procedure.

In this case, when the molecular weight of water vapor is assumed to be 18, and the gas constant R is 461.5149 [J/K/kg] per kilogram is obtained by converting the gas constant (8.3144598 [J/K/mol]) of water vapor per mole. The specific heat of water Cw is denoted as 1007 [J/K/kg], the heat transfer coefficient H of water vapor in a natural convection state without wind at room temperature is denoted as 4.2 [W/m2/K], the room temperature is denoted as Troom [degrees Celsius], and the water vapor pressure in the atmosphere in the vehicle is denoted as ES [Pa].

An air density pair is expressed by the following formula.

ρair=(1.2923/(1+0.00366×T))×((101325−0.378×ES)/101325) [kg/m3]

An empirical formula of a water diffusion coefficient Dair of air at the atmospheric pressure is expressed by the following formula.

Dair=0.241×((Troom+273.15)/288)1.75×10−4 [m2/s]

A heat diffusion coefficient TDair of air is expressed by the following formula.

TDair=(0.1356×Troom+18.51)×10−6 [m2/s]

A vapor transfer coefficient Hwater according to the vapor pressure difference on the water surface in a windless state converted from the heat transfer coefficient is expressed by the following formula.

Hwater=H×(Dair/TDair) (2/3)/(R×Cw×(Troom+273.15)×Dair) [kg/s/m2/Pa]

The relative water absorption rate FRH of the outermost surface of the anti-fog film 120 in the equilibrium state with air at a certain relative humidity is substantially equal to the relative humidity of air. When the temperature decreases, the saturation water vapor pressure of air greatly decreases, but the saturation water absorption mass concentration FW of the anti-fog film 120 is substantially constant, and only the water vapor pressure decreases.

In this case, by using the relative humidity RH [%] and the saturation water vapor pressure EW [Pa] of air, the water vapor pressure ES [Pa] of air in the vehicle-cabin is expressed by the following formula.

ES=EW×RH

Also, by using the water absorption mass concentration FD [kg/m3] of the anti-fog film 120 and the saturation water absorption mass concentration FW [kg/m3] of the anti-fog film 120, the relative water absorption rate FRH [%] of the outermost surface of the anti-fog film 120 is expressed by the following formula.

FRH=FD/FW

Where the saturation water vapor pressure of the glass main body 111 with respect to air is denoted as EWF [Pa] at a certain temperature, the water vapor pressure Fs of the anti-fog film 120 is expressed by the following formula.

Fs=EWF×FRH [Pa]

The water absorption velocity FWS (Flow Water Surface) [kg/m2/s] of the outermost surface of the anti-fog film 120 is expressed by the following formula.

FWS=(ES−FS)×Hwater

The water diffusion coefficient D [m2/s] of the inner portion of the anti-fog film 120 can be derived as follows. Where the diffusion activation coefficient of the outermost surface of the anti-fog film 120 with respect to water vapor is denoted as α, the gas constant is denoted as R (=461.5149) [J/K/kg], the water activation energy of the inner portion of the film is denoted as eFilm (=2.8×106) [J], and the glass temperature is denoted as Tg [K], the water diffusion coefficient D is expressed by the following formula.

D=α×Exp(−eFilm/R/(Tg+273.15))

Non-stationary analysis of the water absorption mass concentration distribution FD (x, t) [kg/m3] of the anti-fog film 120 is analyzed according to a finite-difference method using the following diffusion equation.

∂FD(x)/∂t=D×∂2FD(x)/∂x2+FWS . . . (x=0)

∂FD(x)/∂t=D×∂2FD(x)/∂x2 . . . (0<x<d)

∂FD(x)/∂t=0 . . . (x=d)

The non-stationary analysis is solved by a dimensionless water absorption volume concentration U(x, t). The water absorption mass concentration FD(x, t) of the anti-fog film 120 is given by the following formula. In this case, C denotes a concentration of water, i.e., 1000 [kg/m3].

FD(x, t)=U(x, t)×C [kg/m3]

The non-stationary analysis is performed in such a range that the film thickness x is 0 [m] to d [m]. For example, the anti-fog film 120 is treated as being divided in the thickness direction. For example, in a case where the film thickness of the anti-fog film 120 is 20 μm, the anti-fog film 120 is divided into 10 portions with an interval of 2 lam from the uppermost layer to the lowermost layer in the thickness direction. FD (x=0, t) is a water absorption mass concentration in the uppermost layer of the anti-fog film 120 that is in contact with air. FD (x=d, t) is a water absorption mass concentration in the lowermost layer of the anti-fog film 120 that is in contact with the glass main body 111. In the difference analysis, for example, the water absorption mass concentration FD (x=0, t) in the uppermost layer of the anti-fog film 120 is evaluated for a certain period of time. The time t=0 [s] represents a time when the water absorption mass concentration of the uppermost layer of the anti-fog film 120 is predicted. In the invention of the present application, the uppermost layer of the anti-fog film 120 means a layer that is in contact with air when the anti-fog film 120 is divided in the thickness direction at a predetermined thickness. The predetermined thickness is set as necessary according to the purposes.

The non-stationary analysis is preferably performed continuously after the analysis is first started.

In order to solve the diffusion equation that is a partial differential equation, it is appropriate to perform calculation by an explicit method with forward difference for the time and with central difference for the space, because there are discontinuous points in tams of analysis, where fogging occurs in the uppermost layer due to water absorption saturation in the film in its calculation.

The water absorption volume concentration U(x, 0) [kg/m3] of the initial condition at the time t=0 is U(x, 0)=U0 (0≤x≤d). The boundary condition is a change U(0, t) of the water absorption volume concentration of the uppermost layer and a change U(d, t) of the water absorption volume concentration of the lowermost layer. U0 is the initial uniform equilibrium water absorption volume concentration [kg/m3] of the inside of the film.

From the formula of the stability of the solution of the explicit method, the limit range of dt for the time forward difference is as follows.

dt<dx2/2/(Hwater×dx+D)×C×ρ [s],

where dx denotes the thickness [m] at which the film thickness is divided, Hwater denotes a vapor transfer coefficient [kg/s/m2/Pa], D denotes the inside of the film diffusion coefficient [m2/s], C denotes a concentration of water 1000 [kg/m3], and p denotes the specific heat of water [J/kg/K].

U(x=0, t+dt) at the time t+dt of the water absorption volume concentration of the outermost surface of the anti-fog film 120 is expressed by the following formula.

U(0, t+dt)=Hwater/C/ρ×(ES−FW)×dt×dx+(1−2×D/C/ρ×(dt/dx2))×U(0,t)+D/C/ρ×(dt/dx2)×U(dx,t)

U(x, t+dt) at the time t+dt of the water absorption volume concentration in the inside of the film (at a position of a depth x from the surface) of the anti-fog film 120 is expressed by the following formula.

U(x,t+dt)=D/C/ρ×(dt/dx2)×U(x−dx,t)+(1−2×D/C/ρ×(dt/dx2))×U(x,t)+D/C/ρ×(dt/dx2)×U(x+dx,t)

U(x=d,t+dt) at the time t+dt of the water absorption volume concentration in the lowermost layer (x=d) of the anti-fog film 120 is expressed by the following formula.

U(x=d,t+dt)=D/C/ρ×(dt/dx2)×U(d−dx,t) (1−2×D/C/ρ×(dt/dx2))×U(dt)+D/C/ρ×(dt/dx2)×U(d−dx,t)

According to the above configuration, in order to prevent fogging of the anti-fog film 120, for example, the control unit 150 may perform control as follows.

In a case where FD (x=0)<FW in comparison between the saturation water absorption mass concentration FW [kg/m3] of the anti-fog film 120 and the water absorption mass concentration FD (x=0) of the uppermost layer of the anti-fog film 120, fogging does not occur. When FD (x=0)≥FW is satisfied, condensed water exceeding the saturation water absorption mass concentration FW of the anti-fog film 120 results in fogging and is precipitated on the surface.

A time duration Ts until FD (x=0)≥FW is satisfied and fogging occurs on the anti-fog film 120 (i.e., a required time duration from the time at which the water absorption mass concentration FD (x=0) of the uppermost layer of the anti-fog film 120 is predicted to the time at which fogging is expected to occur) is derived, and when the time duration Ts becomes, for example, 30 seconds or less (Ts≤30 [s]), or preferably, the time duration Ts becomes 10 seconds or less (Ts≤10 [s]), the controller 150C causes the electric heating wire 130 to be in the energized state by turning ON the switch 140 to activate the drying mode.

The time duration Ts until FD (x=0)≥FW is satisfied and fogging occurs on the anti-fog film 120 is calculated by predicting the water absorption mass concentration FD (x=0) of the outermost surface of the anti-fog film 120 up until a predetermined time (for example, 10 minutes) as follows.

A time step dti of the i-th time step dti in the calculation for predicting the water absorption mass concentration FD (x=0) for 10 minutes (600 [s]) in the future from the point in time of the calculation is variable, but hereinafter, the time step dti is assumed to be constant for the sake of explanation.

At each time step t=0, 1×dt, 2×dt, 3×dt, 4×dt, 5×dt, (n−1)×dt, n×dt, (n+1)×dt, . . . , 600 [s], the water absorption mass concentration FD (x=0) [kg/m3] of the uppermost layer of the anti-fog film 120 is calculated successively.

At a time Tn−1=Σdti (Ii=1 to n−1) of the (n−1)-th step, the following relationship is satisfied between the water absorption mass concentration FD (0, Tn−1) of the uppermost layer of the anti-fog film 120 and the saturation water absorption mass concentration FW.

FD (0, Tn−1) [kg/m3]<FW [kg/m3]

At the time Tn=Σdti (i=1 to n) of the n-th step, the following formula is satisfied between the water absorption mass concentration FD (0, Tn) of the uppermost layer of the anti-fog film 120 and the saturation water absorption mass concentration FW. The required time duration from the time at which the water absorption mass concentration (x=0) of the uppermost layer of the anti-fog film 120 is predicted to the time Tn is defined as a time duration Ts until fogging occurs on the anti-fog film 120.

FD (0, Tn) [kg/m3]≥FW [kg/m3]

Specifically, for example, when the time duration Ts becomes 30 seconds or less (Ts≤30 [s]), or preferably when the time duration Ts becomes 10 seconds or less (Ts≤10 [s]), the controller 150C causes the electric heating wire 130 or the electric heating film to be in the energized state.

Then, in the calculation, when the relative water absorption rate FRH (x=0) of the outermost surface of the anti-fog film 120 becomes, for example, 80% or less (FRH (x=0) 80%), the controller 150C can cause the electric heating wire 130 or the electric heating film to be in the non-energized state.

In the above explanation, for example, the electric heating wire 130 or the electric heating film is caused to be in the energized state in order to dry the anti-fog film 120, but instead of causing the electric heating wire 130 or the electric heating film to be in the energized state, or in addition to causing the electric heating wire 130 or the electric heating film to be in the energized state, e.g., the defroster 20 may be turned ON, the air conditioner may be switched from the inside air mode to the outside air mode, or the humidifier may be stopped.

Also, the time duration Ts until fogging occurs on the anti-fog film 120 is preferably, repeatedly calculated with a predetermined control cycle after the analysis is started initially.

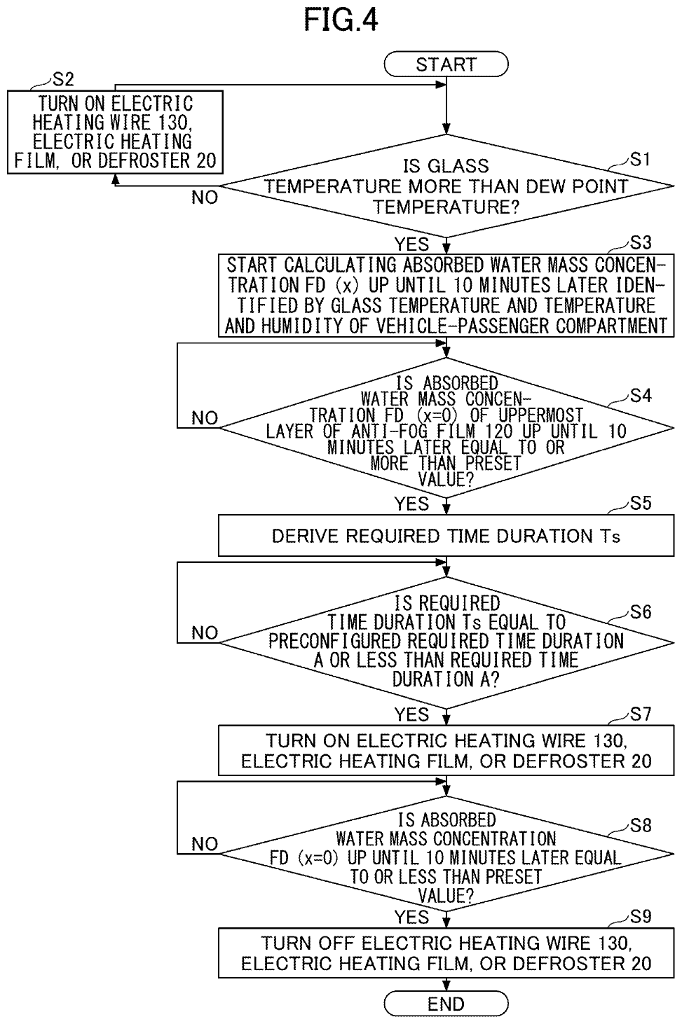

FIG. 4 is a drawing illustrating a flowchart of processing executed by the controller 150C.

The controller 150C starts the processing when the power supply is turned ON by the ECU.

The controller 150C determines whether the glass temperature is more than the dew point temperature on the basis of the glass temperature detected by the temperature sensor 150A and the temperature and the humidity of the vehicle-cabin detected by the temperature-and-humidity sensor 150B (step S1). However, in the present invention, step S1 is not mandatory processing.

When the glass temperature is not in a condition of exceeding the dew point temperature (S1: NO), the controller 150C causes the electric heating wire 130 or the electric heating film to be in the energized state, or turns on the defroster 20 (step S2). The controller 150C repeatedly executes the processing of steps S1 and S2 until it is determined that the glass temperature is in the condition of exceeding the dew point temperature (S1: YES).

When the controller 150C determines that the glass temperature is in the condition of exceeding the dew point temperature (S1: YES), the controller 150C starts calculating the water absorption mass concentration FD (x) up until, for example, 10 minutes later identified by the glass temperature and the temperature and the humidity of the vehicle-cabin (step S3). 10 minutes are counted from the time at which the water absorption mass concentration FD (x) is calculated.

The controller 150C determines whether the water absorption mass concentration FD (x=0) of the uppermost layer of the anti-fog film 120 up until 10 minutes later is equal to or more than a preset value (step S4).

When the water absorption mass concentration FD (x=0) up until 10 minutes later is determined not to be equal to or more than a preset water absorption mass concentration value (S4: NO), the controller 150C repeatedly executes the processing of step S4 without proceeding to step S5.

When the controller 150C determines that the water absorption mass concentration FD (x=0) up until 10 minutes later is equal to or more than the preset value (S4: YES), the controller 150C derives the time (the remaining time) Ts until fogging occurs on the anti-fog film 120 (step S5). The time duration Ts may be derived by the controller 150C according to the above method.

The controller 150C determines whether the time duration Ts derived in step S5 is equal to a preconfigured time duration A or is less than the preconfigured time duration A (step S6).

In a case where the time duration Ts is not equal to the preconfigured time duration A and is not less than the preconfigured time duration A, the controller 150C repeatedly executes the processing of step S6 without proceeding to step S7.

When the time duration Ts is equal to the time duration A configured in advance or is less than the time duration A (S6: YES), the controller 150C causes the electric heating wire 130 or the electric heating film to be in the energized state or turns on the defroster 20 (step S7).

The controller 150C determines whether the water absorption mass concentration FD (x=0) up until 10 minutes later, which is continuously calculated, is equal to or less than a preset value (step S8). For example, in a case where the water absorption mass concentration FD (x=0) up until 10 minutes later is more than the preset value, the controller 150C repeatedly executes the processing of step S8 without proceeding to step S9.

When the water absorption mass concentration FD (x=0) up until 10 minutes later reaches the preset value or less (S8: YES), the controller 150C causes the electric heating wire 130 or the electric heating film to be in the non-energized state or turns OFF the defroster 20 (step S9).

The series of processing is finished here. While the power supply of the window glass system 100 is in the ON state, the controller 150C repeatedly executes the processing from step S1 to S9 with a predetermined control cycle.

Hereinabove, according to the embodiment, the water absorption mass concentration FD (x=0) of the uppermost layer of the anti-fog film 120 from the point in time at which the water absorption mass concentration FD (x=0) is predicted to the point in time that is, for example, 10 minutes later is calculated on the basis of the glass temperature and the temperature and the humidity of the vehicle-cabin, and the time duration Ts until fogging occurs on the uppermost layer of the anti-fog film 120 is derived.

Then, when the time duration Ts becomes, for example, 30 seconds or less (Ts≤30 [s]), or preferably when the time duration Ts becomes 10 seconds or less (Ts≤10 [s]), the electric heating wire 130 or the electric heating film is caused to be in the energized state or the defroster 20 is turned on by activating the drying mode.

Accordingly, an occurrence of fogging on the anti-fog film 120 of the window glass 110 can be alleviated in advance.

Therefore, the window glass system 100 with improved anti-fog performance can be provided.

Also, hereinabove, the aspect in which the control unit 150 is provided on the vehicle cabin-side surface of the glass main body 111 has been explained, but the control unit 150 may be provided on the colored ceramic layer 112 or the colored organic ink layer of the vehicle cabin-side of the glass main body 111. In this case, the temperature detected by the temperature-and-humidity sensor 150B is affected by the colored ceramic layer 112 or the colored organic ink layer, and therefore, the detected temperature may be converted to a value at the central portion 111A. For the conversion, for example, a conversion formula may be used.

Also, hereinabove, the aspect in which the controller 150C is included in the control unit 150 and provided on the vehicle cabin-side surface of the glass main body 111 has been explained, but the position where the controller 150C is provided is not limited to such a position. For example, the controller 150C may be connected to the temperature-and-humidity sensor 150B via a cable, and does not have to be provided on the glass main body 111. Also, the controller 150C may be provided at any given point in a cable connecting the temperature-and-humidity sensor 150B or the switch 140 and the ECU of the vehicle 10.

Also, hereinabove, the aspect in which the controller 150C causes the electric heating wire 130 to be in the energized state on the basis of the temperature and the humidity detected by the temperature-and-humidity sensor 150B has been explained, but instead of the electric heating wire 130 or in addition to the electric heating wire 130, the defroster 20 of the vehicle 10 may be activated.

Also, hereinabove, the method in which the controller 150C estimates the time duration Ts until fogging occurs on the anti-fog film 120 on the basis of the glass temperature and the temperature and the humidity of the vehicle-cabin detected by the temperature sensor 150A and the temperature-and-humidity sensor 150B has been explained, but the time duration Ts may be estimated on the basis of the vehicle speed, the temperature of the outside of the vehicle-cabin, and the temperature of the vehicle-cabin. For example, the glass temperature may be derived from the vehicle speed, the temperature of the outside of the vehicle-cabin, and the temperature of the inside of the vehicle-cabin, and the time duration Ts may be estimated on the basis of the glass temperature, the temperature of the vehicle-cabin, and the humidity of the vehicle-cabin that have been derived. In this case, a vehicle speed sensor for detecting the vehicle speed and a vehicle-external temperature sensor detecting the temperature of the outside of the vehicle-cabin may be provided instead of the temperature sensor 150A.

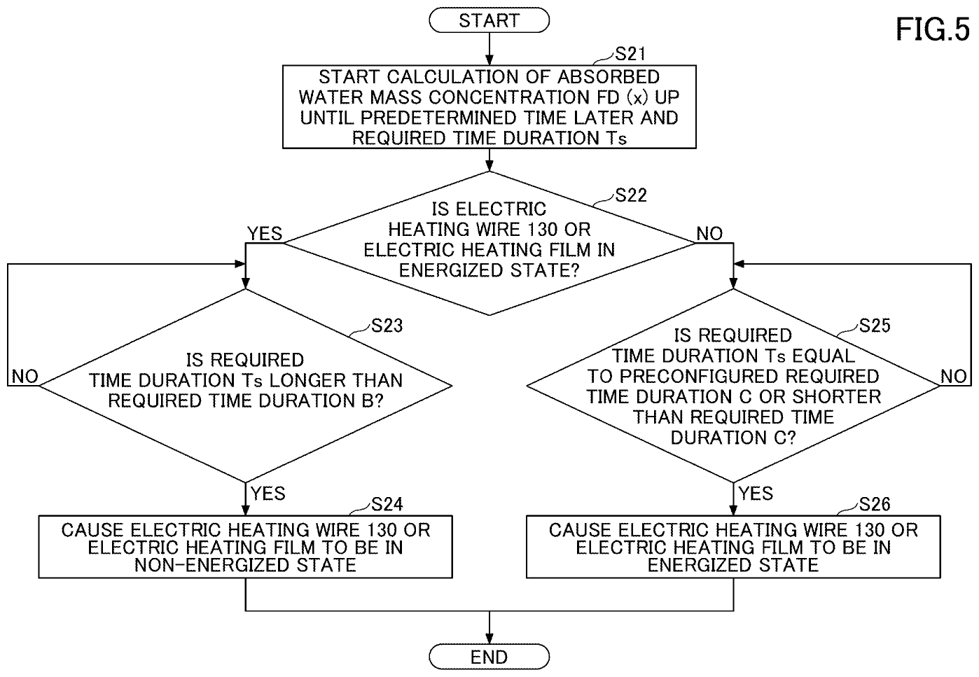

Alternatively, the processing executed by the controller 150C may be as illustrated in FIG. 5. FIG. 5 is a flowchart illustrating processing executed by a controller 150C according to a modified embodiment of the embodiment.

When the controller 150C starts processing, the controller 150C starts calculation of the water absorption mass concentration FD (x) up until a predetermined time later and the time duration Ts until fogging occurs on the anti-fog film 120 (step S21).

The controller 150C determines whether the electric heating wire 130 or the electric heating film is in the energized state (step S22).

When the controller 150C determines that the electric heating wire 130 or the electric heating film is in the energized state (S22: YES), the controller 150C determines whether the time duration Ts is more than a preconfigured time B (step S23).

In a case where the time duration Ts is not more than the preconfigured time B, the controller 150C repeatedly executes the processing of step S23 without proceeding to step S24. As a result, the electric heating wire 130 or the electric heating film is maintained in the energized state.

When the controller 150C determines that the time duration Ts is more than the preconfigured time B (S23: YES), the controller 150C causes the electric heating wire 130 or the electric heating film to be in the non-energized state (step S24). When the controller 150C finishes the processing of step S24, the controller 150C ends the series of processing.

In step S22, when the controller 150C determines that the electric heating wire 130 or the electric heating film is in the non-energized state (S22: NO), the controller 150C determines whether the time duration Ts is equal to a preconfigured time C or less than the preconfigured time C (step S25).

When the controller 150C determines that the time duration Ts is not equal to the preconfigured time C and is not less than the time C (S25: NO), the controller 150C repeatedly executes the processing of step S25 without causing the flow to proceed to step S26. As a result, the electric heating wire 130 or the electric heating film is maintained in the non-energized state.

When the controller 150C determines that the time duration Ts is equal to the preconfigured time C or less than the preconfigured time C (S25: YES), the controller 150C causes the electric heating wire 130 or the electric heating film to be in the energized state (step S26).

The series of processing is finished here. While the power supply of the window glass system 100 is in the ON state, the controller 150C executes the processing from step S21 to S24 and the processing from step S21 to S26 with a predetermined control cycle.

In this case, the preconfigured time B is preferably more than the time C. When the time B is more than the time C, malfunction of the electric heating wire 130 or the electric heating film can be alleviated. Also, the power consumption can be alleviated. The difference between the time B and the time C is preferably equal to or more than 100 seconds, and is more preferably equal to or more than 150 seconds.

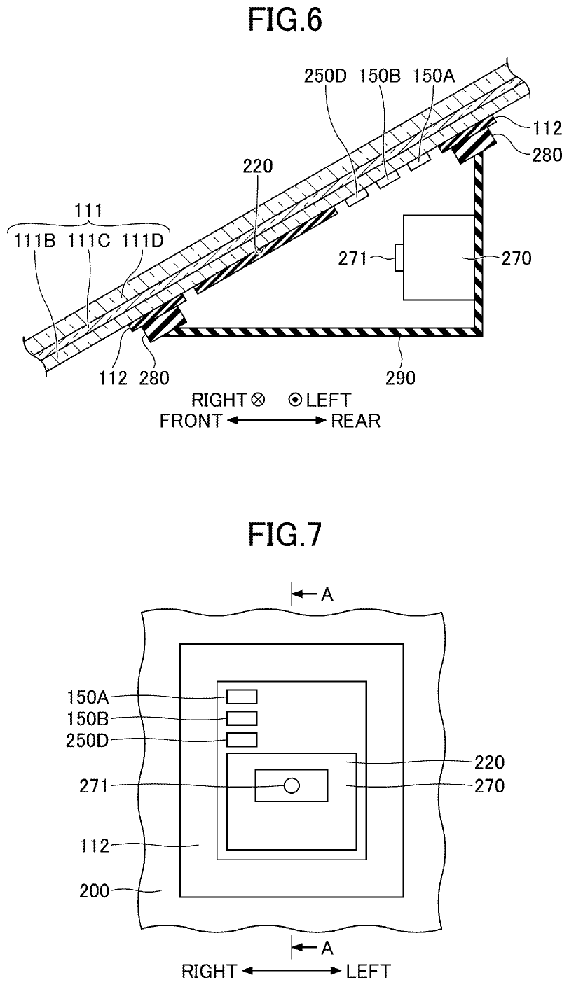

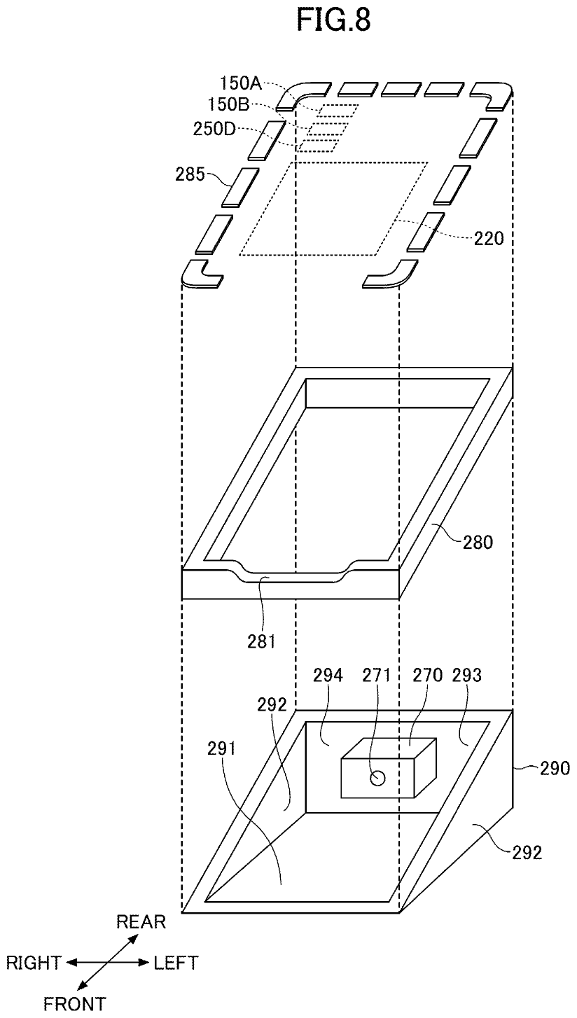

As illustrated in FIG. 6 to FIG. 8, the window glass 110 may include an information acquisition apparatus 270 for obtaining information about the outside of the moveable body. FIG. 6 to FIG. 8 are drawings illustrating a structure of a bracket 280 and a housing 290 for attaching the information acquisition apparatus 270 to the glass main body 111. FIG. 6 is a drawing illustrating a cross section taken along A-A indicated by arrows in FIG. 7, and FIG. 7 is a front view. In this explanation, the upper and lower directions mean directions when the information acquisition apparatus 270, the bracket 280, and housing 290 are attached to the glass main body 111 as illustrated in FIG. 6. In FIG. 6, the left direction corresponds to the front side of the vehicle, and the right direction corresponds to the rear side of the vehicle. A direction penetrating the sheet of the drawing corresponds to the lateral direction (sideways), a direction penetrating the sheet of the drawing from the front side to the rear side corresponds to a right direction, and a direction penetrating the sheet of the drawing from the rear side to the front side corresponds to a left direction. The left and the right mean the left-hand side and the right-hand side with respect to the travelling direction of the vehicle 10 (see FIG. 1). In the following explanation, the longitudinal direction and the lateral direction (sideways) are used. FIG. 6 and FIG. 8 indicate the front, rear, left, and right directions, and FIG. 7 indicates the left and right directions.

In FIG. 6, the glass main body 111 is laminated glass in which an interlayer film 111C is sealed between glass plates 111B and 111D. The colored ceramic layer 112, the electric heating wire 130 (not illustrated), an anti-fog film 220, the temperature sensor 150A, the temperature-and-humidity sensor 150B, and a wind speed sensor 250D are attached to the vehicle cabin-side surface of the glass plate 111B. In a case where the controller 150C is also attached, the controller 150C is preferably provided in proximity to the information acquisition apparatus 270. The information acquisition apparatus 270 is often provided at a location that is less likely to be affected by solar radiation, and accordingly, the controller 150C can also avoid the adverse effect of solar radiation in a similar manner. The electric heating wire 130 may be provided between two pieces of glass. In the window glass system 100 according to the present invention, the electric heating wire 130 may be replaced with an electric heating film.

The colored ceramic layer 112 is attached, to the portion where the bracket 280 is attached, in a rectangular annular shape when the glass main body 111 is seen from the front.

On the vehicle cabin-side surface of the glass plate 111B of the glass main body 111, the anti-fog film 220 is famed in a portion excluding the upper end side in an area enclosed by the colored ceramic layer 112. The anti-fog film 220 is located on the front surface of the information acquisition unit 271 of the information acquisition apparatus 270, and is provided to alleviate an occurrence of fogging of the glass main body 111 on the front surface of the information acquisition unit 271.

The temperature sensor 150A, the temperature-and-humidity sensor 150B, and the wind speed sensor 250D are provided, without overlapping with the anti-fog film 220, in an area enclosed by the colored ceramic layer 112 on the vehicle cabin-side surface of the glass plate 111B of the glass main body 111. For example, the temperature sensor 150A, the temperature-and-humidity sensor 150B, and the wind speed sensor 250D are provided on the upper side of the anti-fog film 220. The wind speed sensor 250D may be a hot-wire anemometer and an ultrasonic anemometer.

The information acquisition apparatus 270 may be an image-capturing apparatus such as a camera, an optical reception apparatus receiving signals of a radar or an optical beacon, and the like. The information acquisition apparatus 270 is fixed to the window glass 110 via the bracket 280 and the housing 290. The bracket 280 and the housing 290 are examples of an attachment member. The information acquisition apparatus 270 includes an information acquisition unit 271, and is configured to acquire information about the forward direction of the vehicle 10 by obtaining images and signals of a radar or an optical beacon with the information acquisition unit 271.

In the glass main body 111, an area on the front surface of the information acquisition unit 271 is an example of an information acquisition area. The anti-fog film 220 is provided at least in the information acquisition area of the window glass 110.

The bracket 280 is a frame-shaped member in the rectangular annular shape, and includes a concave portion 281 on the upper surface side in the forward direction. The bracket 280 is, for example, made of resin.

As illustrated in FIG. 8, the housing 290 includes a bottom portion 291 in a rectangular plate shape, side walls 292 in a triangular plate shape, and a back surface wall 293 in a rectangular plate shape. The side walls 292 extend upward from the side edges of the bottom portion 291, and the back surface wall 293 extends upward from the rear edge of the bottom portion 291. A space enclosed by the bottom portion 291, the side walls 292, and the back surface wall 293 is an accommodation portion 294, and the information acquisition apparatus 270 fixed to the surface on the front side of the back surface wall 293 is located inside the accommodation portion 294. The housing 290 is, for example, made of resin.

In the housing 290 as explained above, the front edge of the bottom portion 291 and the upper edges of the side walls 292 and the back surface wall 293 are bonded to the lower surface of the bracket 280, and further, the bracket 280 is affixed, via an adhesive layer 285, to the colored ceramic layer 112 on the vehicle cabin-side surface of the glass plate 111B of the glass main body 111. The adhesive layer 285 is divided along the rectangular annular shape of the bracket 280, and is not provided in the concave portion 281 of the bracket 280.

When the bracket 280 bonded to the housing 290 is attached with the adhesive layer 285 to the vehicle cabin-side surface of the glass plate 111B, there is a gap between the concave portion 281 of the bracket 280 and the vehicle cabin-side surface of the glass plate 111B. Also, between a portion other than the concave portion 281 of the bracket 280 and the vehicle cabin-side surface of the glass plate 111B, there are gaps in the sections that are not bonded with the adhesive layer 285.

Through these gaps, air in the vehicle cabin-side flows into the accommodation portion 294 of the housing 290. In particular, the gap formed in the portion of the concave portion 281 is large, and faces in a diagonally lower direction on the forward side, and accordingly, for example, air that is conditioned by an air conditioner flows into the accommodation portion 294.

Therefore, the wind speed sensor 250D can detect the wind speed of the wind from the air conditioner. The temperature sensor 150A can detect the temperature in proximity to the glass main body 111, and the temperature-and-humidity sensor 150B can detect the temperature and the humidity of the space enclosed by the attachment member.

Also, when the defroster 20 is turned ON, air dehumidified by the defroster 20 flows into the accommodation portion 294 through the concave portion 281 and blows onto the anti-fog film 220 and flows out through the gaps other than the concave portion 281. Therefore, the water absorption mass concentration FD (x=0) of the uppermost layer of anti-fog film 220 can be reduced efficiently, and the operating time of the defroster 20 can be shortened.

The temperature sensor 150A and the temperature-and-humidity sensor 150B are preferably provided in proximity to the gaps of the sections where the adhesive layer 285 is divided. When the temperature sensor 150A and the temperature-and-humidity sensor 150B are provided in proximity to the gaps of the sections where the adhesive layer 285 is divided, the water absorption mass concentration FD (x=0) of the uppermost layer of the anti-fog film 220 can be accurately calculated. The position where the temperature sensor 150A and the temperature-and-humidity sensor 150B are provided is, in the plan view, preferably within a radius of 50 mm, more preferably within a radius of 40 mm, and still more preferably within a radius of 30 mm from the gap.

When the wind speed sensor 250D is used, the formula for deriving the heat transfer coefficient H can be replaced with the following formula for deriving the heat transfer coefficient H in view of the wind speed V [m/s] of the vehicle-cabin to calculate the time duration Ts until fogging occurs on the anti-fog film 220.

H=5.8+4.2V [W/m2/K]

The wind speed sensor 250D is preferably provided in the portion where the air dehumidified by the defroster 20 passes. Therefore, in this case, for example, the wind speed sensor 250D is provided on the side closer to the concave portion 281 of the bracket 280 than are the temperature sensor 150A and the temperature-and-humidity sensor 150B. The wind speed sensor 250D is provided close to the gaps of the sections where the adhesive layer 285 is divided.

When the wind speed sensor is provided in proximity to the gaps, the water absorption mass concentration FD (x=0) of the uppermost layer of the anti-fog film 220 can be calculated furthermore accurately. The position where the wind speed sensor is provided is, in the plan view, preferably within a radius of 100 mm, more preferably within a radius of 80 mm, and still more preferably within a radius of 50 mm from the gaps of the sections where the adhesive layer 285 is divided.

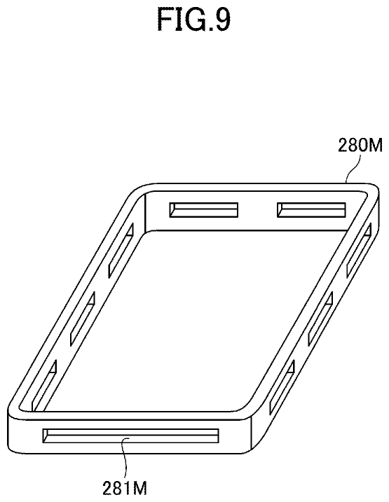

Instead of the bracket 280 as illustrated in FIG. 6 to FIG. 8, a bracket 280M as illustrated in FIG. 9 may be used. FIG. 9 is a drawing illustrating the bracket 280M according to a modified embodiment of the embodiment.

The bracket 280M includes opening portions 281M. When the bracket 280M is used, air that is dried by the defroster 20 flows into the space enclosed by the bracket 280M and the housing 290, and therefore, similarly with the case where the bracket 280 as illustrated in FIG. 6 to FIG. 8 is used, the water absorption mass concentration FD (x=0) of the uppermost layer of the anti-fog film 220 can be reduced efficiently, and the operating time of the defroster 20 can be shortened. When the wind speed sensor 250D is used, the formula for deriving the heat transfer coefficient H can be replaced with the following formula for deriving the heat transfer coefficient H in view of the wind speed V [m/s] of the vehicle-cabin to calculate the time duration Ts until fogging occurs on the anti-fog film 220.

Hereinabove, the window glass system and the window glass according to the exemplary embodiments of the present invention have been explained, but the present invention is not limited to the specifically disclosed embodiments, and can be modified and changed in various manners without deviating from the scope of the claims.

What is claimed is:

1. A window glass system comprising:
a window glass to be attached to a moveable body;
an anti-fog film to be provided on a cabin-side surface of the window glass;
a temperature sensor configured to detect a glass temperature of the vehicle cabin-side surface of the window glass;
a temperature-and-humidity sensor configured to detect a temperature and a humidity of a cabin of the moveable body;
drying means configured to vaporize water attached to the anti-fog film; and
a processing circuitry configured to estimate a time duration Ts, based on the glass temperature detected by the temperature sensor and the temperature and the humidity of the cabin detected by the temperature-and-humidity sensor, the time duration Ts being a duration of time until fogging occurs on the anti-fog film, and activate the drying means based on the time duration Ts.

2. The window glass system according to claim 1, wherein the time duration Ts is estimated based on a water absorption mass concentration FD (x=0) of an uppermost layer of the anti-fog film.

3. The window glass system according to claim 2, wherein, where a saturation water absorption mass concentration of the anti-fog film is denoted as FW, the time duration Ts is a required time from a time at which the water absorption mass concentration FD (x=0) of the uppermost layer of the anti-fog film is predicted to a time at which FD (x=0) FW is satisfied.

4. The window glass system according to claim 1, wherein the processing circuitry repeatedly estimates the time duration Ts.

5. The window glass system according to claim 1, wherein the drying means is an electric heating wire or an electric heating film, and
in a plan view, the temperature sensor is provided in a heating area by the drying means.

6. The window glass system according to claim 1, wherein the window glass includes a shielding area, and
in a plan view, the temperature sensor is provided in the shielding area.

7. The window glass system according to claim 1, wherein the temperature sensor is provided on an upper portion or a side portion of the window glass.

8. The window glass system according to claim 1, wherein, in a plan view, the temperature sensor is provided outside of an area where the anti-fog film is provided.

9. The window glass system according to claim 5, wherein in a plan view, a heating area by the drying means includes an area that does not overlap with an area where the anti-fog film is provided.

10. The window glass system according to claim 1, further comprising:
an information acquisition apparatus configured to acquire information about an outside of the moveable body; and
an attachment member fixing the information acquisition apparatus to the window glass,
wherein the anti-fog film is provided in an information acquisition area facing the information acquisition apparatus, and
the temperature-and-humidity sensor is provided in a space enclosed by the attachment member.

11. The window glass system according to claim 10, wherein there is a gap between the window glass and the attachment member, or the attachment member includes an opening portion. 15

12. The window glass system according to claim 1, wherein the temperature sensor and the temperature-and-humidity sensor are provided next to each other.

13. A window glass comprising:
a glass attached to a moveable body;
an anti-fog film to be provided on a vehicle cabin-side surface of the glass;
a temperature sensor configured to detect a glass temperature of the vehicle cabin-side surface of the glass;
a temperature-and-humidity sensor configured to detect a temperature and a humidity of a cabin of the moveable body; and
an electric heating wire or an electric heating film provided in an area that overlaps, in a plan view, with an area where the anti-fog film is provided.

14. The window glass according to claim 13, wherein, in the plan view, the temperature sensor is provided outside of an area where the anti-fog film is provided in a heating area heated by the electric heating wire or the electric heating film.

15. The window glass according to claim 13, wherein the glass includes a shielding area, and
in the plan view, the temperature sensor is provided in the shielding area.
